(19) United States
(12) Patent Application Publication
(10) Pub. No.: US 2022/0307656 A1
(43) Pub. Date: Sep. 29, 2022

(54) VALVE CONTROL SYSTEM AND VALVE CONTROL METHOD

(71) Applicant: CHANGXIN MEMORY TECHNOLOGIES, INC., Hefei City, Anhui (CN)

(72) Inventor: Xueyu LIANG, Hefei City, Anhui (CN)

(73) Assignee: CHANGXIN MEMORY TECHNOLOGIES, INC., Hefei City, Anhui (CN)

(21) Appl. No.: 17/593,033

(22) PCT Filed: Apr. 25, 2021
(86) PCT No.: PCT/CN2021/089602

§ 371 Date: Sep. 4, 2021

(30) Foreign Application Priority Data
Apr. 26, 2020 (CN) 202010338439.0

(51) Int. Cl. F17D 3/01; G05D 16/20

(52) U.S. Cl. CPC F17D 3/01; G05D 16/2026

(57) ABSTRACT

A valve control system and a valve control method can improve working efficiency and security of the operator. The valve control system includes: a regulating valve, mounted to a pipeline to control the opening or closing of the pipeline; an driving device, connected to the regulating valve and configured to control the regulation of the regulating valve; a detector, mounted to the pipeline and configured to detect fluid pressure in the pipeline; a first controller, connected to the driving device and the detector and configured to control the driving device; and a second controller which can perform data interaction with the first controller, wherein the first controller can perform corresponding regulation according to an instruction from the second controller.

### CROSS-REFERENCE TO RELATED APPLICATIONS

The present application claims priority to Chinese Patent Application No. 202010338439.0, entitled “VALVE CONTROL SYSTEM AND VALVE CONTROL METHOD”, filed on Apr. 26, 2020, which is incorporated herein by reference in its entirety.

### TECHNICAL FIELD

The present application relates to the field of a semiconductor factory-side fluid supply system and a semiconductor device, and more specifically to a valve control system and a valve control method.

### BACKGROUND

After a semiconductor production machine is mounted, it is necessary to apply for fluid supply to the factory, for example process cooling water (PCW), to ensure normal operation of the semiconductor production machine. Upon receiving the notice, the operator will arrive at the corresponding valve with ladders and tools and switch on the valve to a corresponding position according to equipment requirements. This process requires the operator to work high above the ground and is thus somewhat dangerous. This process will be repeated again if the initial regulation does not work properly. The efficiency is low. Furthermore, it is quite difficult to find the corresponding valve due to the complicated layout of pipelines in the operating room and poor field of vision.

### SUMMARY

The purpose of the present application is to provide a valve control system and a valve control method, by which the working efficiency can be increased and the security of the operator can be improved.

In order to solve the above technical problem, a valve control system is provided, comprising: a regulating valve, mounted to a pipeline to control the opening or closing of the pipeline; an driving device, connected to the regulating valve and configured to control the regulation of the regulating valve to change the opening or closing of the pipeline; a detector, mounted to the pipeline and configured to detect fluid pressure in the pipeline; a first controller, connected to the driving device and the detector and configured to control the driving device; and a second controller, the second controller can perform data interaction with the first controller, the first controller can perform corresponding regulation according to an instruction from the second controller.

Optionally, connection between the first controller and the second controller comprises wireless signal connection.

Optionally, both the first controller and the second controller are provided with an RF transceiver chip and the data interaction between the first controller and the second controller is realized by transmitting and receiving RF signals by the RF transceiver chip.

Optionally, the detector comprises: a fluid pressure sensor, arranged in the pipeline, connected to the first controller and configured to detect the fluid pressure in the pipeline in real time.

Optionally, the valve control system further comprises: an alarm, connected to the first controller, arranged close to the regulating valve and configured to give an alarm.

Optionally, the valve control system further comprises: a first display, connected to the first controller and configured to display the fluid pressure detected by the detector and an expected fluid pressure value; and a second display, connected to the second controller and configured to display the fluid pressure detected by the detector.

Optionally, the valve control system further comprises: an increase control key, connected to the second controller and configured to control forward rotation of the regulating valve to increase the fluid pressure in the pipeline; a decrease control key, connected to the second controller and configured to control reverse rotation of the regulating valve to decrease the fluid pressure in the pipeline; and a locating control key, connected to the second controller and configured to control the alarm to give an alarm.

In order to solve the above problem, a valve control method is provided, the valve control method is used for controlling the regulating valve in the valve control system, comprising: sending, by the second controller, an instruction to the first controller, to control the regulating valve to regulate by a preset regulating amount so that the pipeline is in a preset open state.

Optionally, the valve control method further comprises: detecting the fluid pressure in the pipeline in real time, and when the fluid pressure in the pipeline does not conform to a fluid pressure corresponding to the preset open state, controlling, by the first controller, the regulating valve to rotate until the fluid pressure in the pipeline conforms to the fluid pressure corresponding to the preset open state.

Optionally, the valve control system further comprises: an alarm, connected to the first controller, arranged close to the regulating valve and configured to give an alarm; and before sending, by the second controller, the instruction to the first controller, to control the regulating valve to regulate by a preset regulating amount so that the pipeline is in a preset open state, further comprises: sending, by the second controller, control information to the first controller, to control the first controller to be connected to the alarm to control the alarm to give an alarm, in order to prompt the location of the regulating valve.

With regard to the valve control system and valve control method in the present application, the regulating valve can be controlled by the second controller that is separated from the first controller. The user can realize the regulation of the regulating valve without touching the first controller. The present application is applicable to scenarios where it is difficult to access to the first controller. It is simple and convenient.

### BRIEF DESCRIPTION OF THE DRAWINGS

In order to explain technical solutions of embodiments of the present application more clearly, the accompanying drawings to be used for describing the embodiments of the present application will be introduced simply. Apparently, the accompanying drawings to be described below are merely some embodiments of the present application. A person of ordinary skill in the art may obtain other drawings according to these drawings without paying any creative effort.

FIG. 1 is a schematic view showing the connection between modules of a valve control system in an embodiment of the present application;

FIG. 2 is a schematic structure diagram of the arrangement of a regulating valve and a detector on the pipeline in an embodiment of the present application;

FIG. 3 is a schematic view showing the connection between a first controller and a second controller in an embodiment of the present application;

FIG. 4 is a schematic view of a second display and various keys in an embodiment of the present application;

FIG. 5 is a schematic view of a first display in an embodiment of the present application; and

FIG. 6 is a diagram of a principle of a circuit for an alarm in an embodiment of the present application.

### DETAILED DESCRIPTION

In order to make the purposes, technical means and effects of the present application more clearly, the present application will be further elaborated with reference to the accompanying drawings. It should be understood that the embodiments to be described here are just some embodiments of the present application, rather than all of the embodiments, and are not intended to limit the present application. Based on the embodiments of the present application, all other embodiments obtained by a person of ordinary skill in the art without paying any creative effort should be included in the protection scope of the present application.

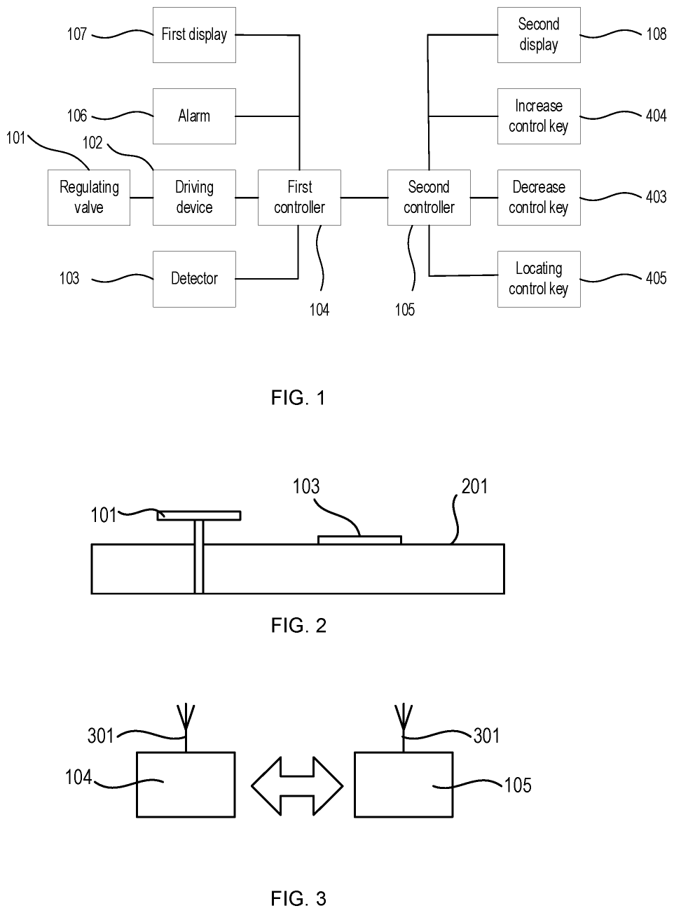

FIG. 1 is a schematic view showing the connection between modules of a valve control system in an embodiment of the present application and FIG. 2 is a schematic structure diagram of the arrangement of a regulating valve and a detector on the pipeline in an embodiment of the present application.

In an embodiment shown in FIGS. 1 to 2, a valve control system is provided, comprising: a regulating valve 101, mounted to a pipeline 201 to control the opening or closing of the pipeline 201; an driving device 102, connected to the regulating valve 101 and configured to control the regulation of the regulating valve 101 to change the opening or closing of the pipeline 201; a detector 103, mounted to the pipeline 201 and configured to detect fluid pressure in the pipeline 201; a first controller 104, connected to the driving device 102 and the detector 103 and configured to control the driving device 102; and a second controller 105 which can perform data interaction with the first controller 104, the first controller 104 can perform corresponding regulation according to an instruction from the second controller 105.

In this embodiment, the valve control system controls the first controller 104 by the second controller 105, thus to control the regulating valve 101. The user does not need to touch the first controller 104. The present application is applicable to scenarios where it is difficult to access to the first controller 104. It is simple and convenient.

FIG. 3 is a schematic view showing the connection between the first controller 104 and the second controller 105 in an embodiment of the present application. In this embodiment, connection between the first controller 104 and the second controller 105 comprises wireless connection. And, when the first controller 104 and the second controller 105 perform data interaction with each other, the distance between the first controller 104 and the second controller 105 is less than a communication distance.

In other embodiments, the first controller 104 and the second controller 105 may be connected in a wired manner. The data interaction between the first controller 104 and the second controller 105 is realized by cables. In this case, the use of cables increases the production cost. Furthermore, when in use, it is limited by the cables. It is less convenient than wireless connection. However, it is simpler for mounting when they are connected in a wired manner.

In an embodiment, the first controller 104 may be arranged near the regulating valve 101. In this way, the user can control the regulating valve 101 near the regulating valve 101. The second controller 105 may be arranged in a handheld terminal and held by the user. In this way, when it is difficult to access to the regulating valve 101, the regulating valve 101 may be controlled by the second controller 105.

In an embodiment, both the first controller 104 and the second controller 105 are provided with an RF transceiver chip and the data interaction between the first controller 104 and the second controller 105 is realized by transmitting and receiving RF signals by the RF transceiver chip. Furthermore, the communication distance is determined by the RF transceiver chip.

In an embodiment, the RF transceiver chip is a ZigBee communication chip, and the communication connectivity between the controllers is established by the ZigBee communication protocol. In this embodiment, the RF transceiver chips respectively arranged in the first controller 104 and the second controller 105 form two nodes in the ZigBee network. In this embodiment, since the effective communication distance of the ZigBee communication chips is usually within 100 m, the second controller 105 should not be too far from the first controller 104. A too large distance, for example more than 100 m, usually leads to unstable connectivity between the second controller 105 and the first controller 104. As a result, it is difficult to perform transmission of data between the two controllers.

In an embodiment, the transmission and reception of RF signals between the two RF signal transceiver chips are realized by an RF antenna 301. In this embodiment, when RF signals are transmitted by an RF signal transceiver chip, the electrical signal communication is converted into a certain radio signal waveform which is then resonantly transmitted by the RF antenna 301. The RF antenna 301 converts electromagnetic waves from the other RF signal transceiver chip to weak AC signals when RF signals are received by an RF signal transceiver chip. The AC signals are filtered, amplified, modulated and demodulated, and then sent to the first controller 104 or the second controller 105 to be further processed. In this embodiment, the RF signal transceiver chip of the first controller 104 mainly functions to transmit the fluid pressure detected by the detector 103 and a driving signal from the driving device 102 to the second controller 105.

In this embodiment, the first controller 104 and the second controller 105 is in one-to-one connection. Each regulating valve 101 corresponds to one first controller 104 which corresponds to one second controller 105. Actually, the many-to-one connection may be used according to actual needs. In this case, a plurality of regulating valves 101 are respectively connected to a plurality of first controllers 104 and the plurality of first controllers 104 are connected to a same second controller 105. In this case, it is necessary to define both the format of data sent by the different first controllers 104 and the format of data sent to the different first controllers 104, so that the first controllers 104 and the second controller 105 can distinguish the source of data.

In an embodiment, the RF signal transceiver chip is a CC2530 chip from the TI Company, containing kernels of 51 single chip microcomputers and the Zigbee technology. Furthermore, the TI Company provides great Zigbee protocol stacks and solutions. It is quite applicable to the field of automated meter reading.

In an embodiment, the detector 103 comprises: a fluid pressure sensor, arranged in the pipeline 201, connected to the first controller 104 and configured to detect the fluid pressure in the pipeline 201 in real time.

In an embodiment, the fluid pressure sensor is an MIK-P300 sensor. The sensing chip of the MIK-P300 sensor is manufactured by the advanced micromechanical etching process. Four high-precision resistors having a temperature compensation function are arranged on the silicon wafer to form a Wheatstone bridge. Due to the piezoresistive effect, the four bridge arm resistances change, and the bridge is out of balance. The sensing element outputs an electrical signal that is indicative of the change in pressure. The output electrical signal is amplified by a 24-bit AD digital chip and compensated by nonlinear correction to generate voltage and current signals that linearly correspond to the input pressure.

The MIK-P300 sensor is compact in structure and easy to mount. It may be mounted directly or by a holder. Furthermore, the MIK-P300 sensor is highly stable and reliable due to the fuel injection isolation process. The damping structure of the MIK-P300 sensor is resistant to shock and RF interference. And, the MIK-P300 sensor is highly precise due to the use of digital circuits.

In an embodiment, the MIK-P300 sensor is mounted at a test port near the regulating valve 101. Actually, the fluid pressure sensors of other types are also mounted at the test port near the regulating valve 101.

In an embodiment, the fluid pressure sensor is mounted 50 cm to 100 cm behind the regulating valve 101. Actually, the specific location of the fluid pressure sensor may be determined according to actual needs. The pressure of fluid in the whole pipeline 201 is the same. Therefore, the location of the fluid pressure sensor is not specifically limited.

In an embodiment, the fluid pressure sensor is also connected to a signal conditioning circuit. Signals output by the fluid pressure sensor are amplified, stabilized and filtered by the signal conditioning circuit, and then subjected to analog-to-digital conversion, to become digital signals that can be recognized by the controller.

In an embodiment, the driving device 102 comprises a servo motor. The servo motor can convert voltage signals into torque and speed to drive the regulation of the regulating valve 101, so as to change the opening or closing of the pipeline 201. The speed of the rotor of the servo is controlled by the input signals and quickly responds to the change of the input signals. The servo motor can convert the received electrical signals into the angular displacement or angular velocity output on the motor shaft. When the electrical signals received by the servo motor are 0, there is no rotation. Therefore, after the regulation of the regulating valve 101 is completed, the regulating valve 101 is in the locked state, thereby avoiding loosening.

In an embodiment, the servo motor is mainly positioned by pulses. Whenever the servo motor receives one pulse, the servo motor rotates by an angle corresponding to one pulse. In this way, the displacement of the servo motor is realized. Since the servo motor itself has a function of generating pulses, the servo motor generates a corresponding number of pulses whenever it rotates by an angle. Those pulses are in cooperation with the pulses received by the servo motor, which may be called closed loop. In this way, the system is aware of the number of pulses sent to the servo motor and the number of pulses received. Therefore, it is able to precisely control the rotation of the motor, thus to realize precise positioning up to 0.001 mm.

In an embodiment, the driving device 102 further comprises a motor driving module. The motor driving module is connected between the first controller 104 and the servo motor to drive the servo motor to rotate clockwise or counterclockwise. In an embodiment, the motor driving module is implemented by a motor driving chip. In this way, a control signal from the first controller 104 may be received to control the servo motor to rotate forward or reversely, and also, a feedback signal detected in the servo motor may be transmitted to the first controller 104. Closed-loop control is formed to complete the control of the regulating valve 101 together.

In an embodiment, the output shaft of the servo motor is welded to the regulating valve 101. Power output by the servo motor may be directly transferred to the regulating valve 101 to drive the regulating valve 101 to perform regulation. In other embodiments, the output shaft of the servo motor may be connected to the regulating valve 101 in other ways, for example, by riveting, by bolts, etc.

In an embodiment, the servo motor uses an encoder to measure the angular displacement of the servo motor. The encoder comprises a light source and a code disk. The code disk rotates together with the moving object. The light source projects rays on the code disk. The surface of the code disk is divided into a bright area and a dark area. Light, transmitted from the bright area, is received by photosensitive elements after passing through a slit. The photosensitive elements are in one-to-one correspondence to code tracks. Signals output by the photosensitive elements in the bright area are 1, and signals output by the photosensitive elements in the dark area are 0. When the code disk rotates to different positions, the combination of signals output by the photosensitive elements reflects a regular digital quantity which represents the angular displacement of the code disk shaft.

In an embodiment, the valve control system further comprises: an alarm 106, connected to the first controller 104, arranged close to the regulating valve 101 and configured to give an alarm.

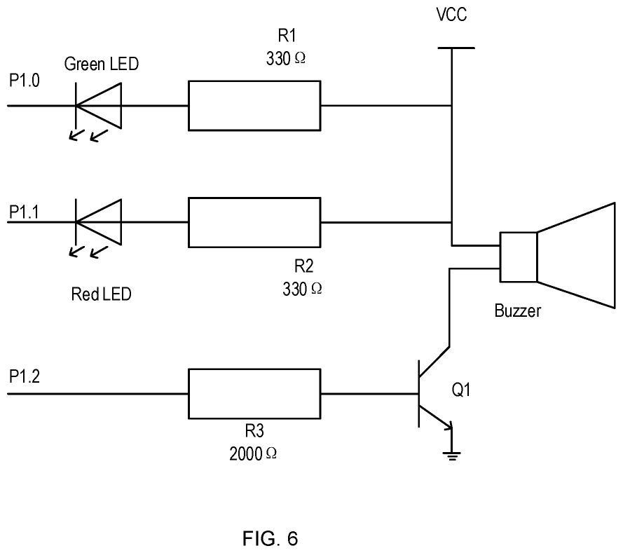

In an embodiment, the alarm 106 comprises a buzzer and an LED lamp. Referring to FIG. 6, in an embodiment as shown, the alarm 106 comprises a red LED lamp and a green LED lamp, and a buzzer. In this embodiment, there are three interfaces which are all connected to the first controller 104. The voltage applied to the three interfaces is controlled by the first controller 104, to control the ON or OFF of the red LED lamp, the green LED lamp, and the buzzer, respectively.

As shown, there are three interfaces P1.1, P1.2 and P1.3. When the alarm 106 is not activated, a low level is applied to the interface P1.0 and the interface P1.2 by the first controller 104, so that the green LED lamp lights, the triode Q1 cuts off, and the buzzer is not turned on. When the alarm 106 is activated, a low level is applied to the interface P1.1 by the first controller 104 and a high level is applied to the interface P1.2 by the first controller 104, so that the red LED lamp lights, the triode Q1 is turned on, and the buzzer sounds.

In this way, the alarm 106 can, once activated, control the red LED lamp to light and the buzzer to sound. Since the alarm 106 is arranged close to the regulating valve 101, the user can determine the location of the regulating valve 101 by determining the location of the alarm 106.

In an embodiment, the distance between the alarm 106 and the regulating valve 101 does not exceed 20 cm. Actually, the distance between the alarm 106 and the regulating valve 101 may be determined according to actual needs.

In an embodiment, the valve control system further comprises: a first display 107, connected to the first controller 104 and configured to display the fluid pressure detected by the detector 103 and an expected fluid pressure value; and a second display 108, connected to the second controller 105 and configured to display the fluid pressure detected by the detector 103.

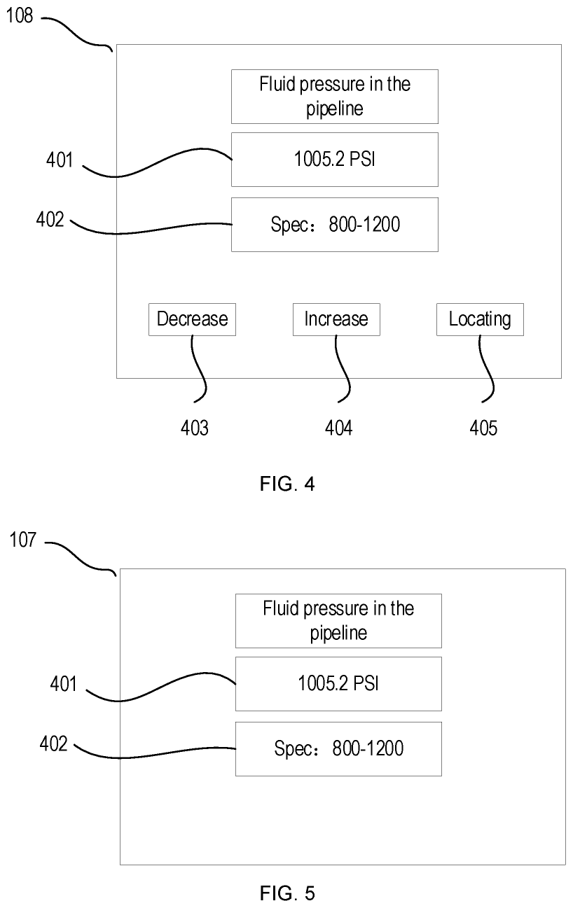

Referring to FIGS. 4 and 5, it may be found that both the first display 107 and the second display 108 have a first display window 401 to display the fluid pressure detected by the detector 103 and a second display window 402 to display the allowable range of the fluid pressure.

In the embodiment shown in FIG. 4, the valve control system further comprises: an increase control key 404, connected to the second controller 105 and configured to control the forward rotation of the regulating valve 101 to increase the fluid pressure in the pipeline 201; a decrease control key 403, connected to the second controller 105 and configured to control the reverse rotation of the regulating valve 101 to decrease the fluid pressure in the pipeline 201; and a locating control key 405, connected to the second controller 105 and configured to control the alarm 106 to give an alarm.

In an embodiment, the alarm 106 may be controlled by the locating control key 405. The alarm 106 is activated when the locating control key 405 is pressed down. In a further embodiment, the alarm 106 may be activated when the detector 103 detects that the fluid pressure in the pipeline 201 exceeds the preset value. In this case, the control instruction comes from the first controller 104. It is convenient for the operator to find the abnormality of the fluid pressure. In this embodiment, corresponding high and low levels are output by the first controller 104 to drive the alarm 106 to work. The working voltage is 5V±1V.

In the embodiment shown in FIG. 4, the increase control key 404, the decrease control key 403 and the locating control key 405 are arranged on the same shell surface as the second display 108. In this embodiment, the second controller and the displays are integrated with the increase control key 404, the decrease control key 403 and the locating control key 405 to form a handheld terminal manipulator. In a further embodiment, the increase control key 404, the decrease control key 403 and the locating control key 405 are arranged on the surface of the first controller 104, so that the user can control the driving device 102 directly by the first controller 104.

In this embodiment, a valve control method is further provided, which is used for controlling the regulating valve 101 in the valve control system, comprising: sending, by the second controller 105, an instruction to the first controller 104, to control the regulating valve 101 to regulate by a preset regulating amount so that the pipeline 201 is in a preset open state.

In this embodiment, by the valve control method, the regulating valve 101 can be controlled by the second controller 105 that is separated from the first controller 104. The user can realize the regulation of the regulating valve 101 without touching the first controller 104. The present application is applicable to scenarios where it is difficult to access to the first controller 104. It is simple and convenient.

In an embodiment, the method further comprises: detecting the fluid pressure in the pipeline 201 in real time, and when the fluid pressure in the pipeline 201 does not conform to a fluid pressure corresponding to the preset open state, controlling, by the first controller 104, the regulating valve 101 to rotate until the fluid pressure in the pipeline 201 conforms to the fluid pressure corresponding to the preset open state.

In this case, the regulating valve 101 may be controlled according to the fluid pressure in the pipeline 201 detected in real time. In this way, the regulating valve 101 is controlled in real time, and the fluid pressure in the pipeline 201 is ensured to be always within a certain range.

In an embodiment, as long as there is a difference of more than 20% between the fluid pressure in the pipeline 201 detected in real time and the preset fluid pressure in the pipeline 201, the first controller 104 starts to control the regulating valve 101 in order to regulate the fluid pressure in the pipeline 201.

Specifically, the first controller 104 has been aware of the change in flow when the regulating valve 101 rotates forward and reversely, for example, the forward rotation of the regulating valve 101 will lead to the increased flow and the reverse rotation thereof will lead to the decreased flow. Upon receiving the fluid pressure in the pipeline 201 detected in real time, the first controller 104 compares it with the preset fluid pressure in the pipeline 201. If the fluid pressure in the pipeline 201 detected in real time is 20% greater than the preset fluid pressure in the pipeline 201, the first controller 104 controls the regulating valve 101 to rotate reversely, in order to decrease the fluid pressure in the pipeline 201, to make the fluid pressure approach the preset fluid pressure in the pipeline 201. When the fluid pressure in the pipeline 201 detected in real time is within ±5% of the preset fluid pressure in the pipeline 201, the first controller 104 stops controlling the regulating valve 101. And, the controller restarts the real-time detection stage. If the fluid pressure in the pipeline 201 detected in real time is 20% lower than the preset fluid pressure in the pipeline 201, the first controller 104 controls the regulating valve 101 to rotate forward, in order to increase the fluid pressure in the pipeline 201, to make the fluid pressure approach the preset fluid pressure in the pipeline 201.

In an embodiment, sending, by the second controller 105, an instruction to the first controller 104, to control the regulating valve 101 to regulate by a preset regulating amount so that the pipeline 201 is in a first open state further comprises: placing the second controller 105 within the communication distance between the first controller 104 and the second controller 105. This is because there is a communication distance no matter the second controller 105 and the first controller 104 are connected in a wired manner or in a wireless manner. Beyond the communication distance, the first controller 104 and the second controller 105 even cannot communicate with each other. In this way, when a control instruction is sent to the first controller by the second controller 105, it is necessary to know the communication distance first, in order to ensure good data interaction between the second controller 105 and the first controller 104.

In an embodiment, the valve control system further comprises: an alarm 106, connected to the first controller 104, arranged close to the regulating valve 101 and configured to give an alarm; and sending, by the second controller 105, an instruction to the first controller 104, to control the regulating valve 101 to regulate by a preset regulating amount so that the pipeline 201 is in a first open state further comprises: sending, by the second controller 105, control information to the first controller 104, to control the first controller 104 to be connected to the alarm 106 to control the alarm to give an alarm, in order to prompt the location of the regulating valve 101.

In this embodiment, sun an arrangement can enable the user to locate the regulating valve 101 quickly, so that the user can find the regulating valve 101 faster. In this way, the user can better control the regulating valve 101.

The foregoing descriptions are merely preferred implementations of the present application. It should be noted that, for a person of ordinary skill in the art, various improvements and modifications may be made without departing from the principle of the present application, and these improvements and modifications shall be deemed as falling into the protection scope of the present application.

What is claimed is:

1. A valve control system, comprising:
a regulating valve, mounted to a pipeline to control the opening or closing of the pipeline;
a driving device, connected to the regulating valve and configured to control regulation of the regulating valve to change the opening or the closing of the pipeline;
a detector, mounted to the pipeline and configured to detect fluid pressure in the pipeline;
a first controller, connected to the driving device and the detector and configured to control the driving device; and
a second controller, the second controller can perform data interaction with the first controller, the first controller can perform corresponding regulation according to an instruction from the second controller.

2. The valve control system according to claim 1, wherein a connection between the first controller and the second controller comprises a wireless signal connection.

3. The valve control system according to claim 2, wherein both the first controller and the second controller are provided with an RF transceiver chip and the data interaction between the first controller and the second controller is realized by transmitting and receiving RF signals by the RF transceiver chip.

4. The valve control system according to claim 1, wherein the detector comprises: a fluid pressure sensor, arranged in the pipeline, connected to the first controller and configured to detect the fluid pressure in the pipeline in real time.

5. The valve control system according to claim 1, further comprising: an alarm, connected to the first controller, arranged close to the regulating valve and configured to give an alarm.

6. The valve control system according to claim 1, further comprising:
a first display, connected to the first controller and configured to display the fluid pressure detected by the detector and an expected fluid pressure value; and
a second display, connected to the second controller and configured to display the fluid pressure detected by the detector.

7. The valve control system according to claim 5, further comprising:
an increase control key, connected to the second controller and configured to control forward rotation of the regulating valve to increase the fluid pressure in the pipeline;
a decrease control key, connected to the second controller and configured to control reverse rotation of the regulating valve to decrease the fluid pressure in the pipeline; and
a locating control key, connected to the second controller and configured to control the alarm to give an alarm.

8. A valve control method for controlling the regulating valve in the valve control system according to claim 1, comprising:
sending, by the second controller, an instruction to the first controller, to control the regulating valve to regulate by a preset regulating amount so that the pipeline is in a preset open state.

9. The valve control method according to claim 8, further comprising:
detecting the fluid pressure in the pipeline in real time, and when the fluid pressure in the pipeline does not conform to a fluid pressure corresponding to the preset open state, controlling, by the first controller, the regulating valve to rotate until the fluid pressure in the pipeline conforms to the fluid pressure corresponding to the preset open state.

10. The valve control method according to claim 8, further comprising: an alarm, connected to the first controller, arranged close to the regulating valve and configured to give an alarm; and before sending, by the second controller, the instruction to the first controller, to control the regulating valve to regulate by a preset regulating amount so that the pipeline is in a preset open state, further comprising:
sending, by the second controller, control information to the first controller, to control the first controller to be connected to the alarm to control the alarm to give an alarm, in order to prompt the location of the regulating valve.
